(19) United States
(12) Patent Application Publication
(10) Pub. No.: US 2021/0144490 A1
(43) Pub. Date: May 13, 2021

(54) METHOD FOR OPERATING A NETWORK, AND HEARING DEVICE

(71) Applicant: Sivantos Pte. Ltd., Singapore (SG)

(72) Inventors: Umut GOEKAY, Koenigswinter (DE); Frank NAUMANN, Bubenreuth (DE)

(21) Appl. No.: 17/095,056

(22) Filed: Nov. 11, 2020

(30) Foreign Application Priority Data
Nov. 11, 2019 (DE) 10 2019 217 400

(51) Int. Cl. H04R 25/00; H04L 29/08; H04L 29/12; G10L 21/0216

(52) U.S. Cl. CPC H04R 25/554; H04R 25/558; G10L 21/0216; H04L 67/1042; H04L 61/6068; H04L 67/125

(57) ABSTRACT

A method is specified for the operation of a network having several hearing devices assigned to different users. Each of the hearing devices has an interface for exchanging data with the other hearing devices. The network is implemented as a ring network, within which a given hearing device is directly connected to only two other hearing devices and only indirectly connected to the remaining hearing devices, so that the data exchange within the network takes place from hearing device to hearing device in sequence. A corresponding hearing device is configured to perform the method.

### CROSS-REFERENCE TO RELATED APPLICATION

This application claims the priority, under 35 U.S.C. § 119, of German application DE 10 2019 217 400, filed Nov. 11, 2019; the prior application is herewith incorporated by reference in its entirety.

### BACKGROUND OF THE INVENTION

### Field of the Invention

The invention relates to a method for operating a network having a plurality of hearing devices, and to a corresponding hearing device.

A hearing device is usually assigned to an individual user and is worn by the user in or on the ear to capture sound from the environment and to output it again in modified form. To this end the hearing device has a microphone, which captures the acoustic signals and converts them into an electrical input signal. This is fed to a signal processor of the hearing device for modification. As a result the signal processor outputs an electrical output signal, which is then converted back into sound via a receiver of the hearing device.

If multiple users each with a hearing device meet together at the same place, it can be useful for hearing devices to connect to each other in a network to exchange data. Hearing devices of different users that are connected together in a network are described, for example, in published, European patent applications EP 1 643 801 A2 and EP 3 101 919 A1, corresponding to U.S. patent publications 2006/0067550 and 2006/0067549 and U.S. Pat. No. 9,949,040.

For data exchange in a network, a hearing device has an interface, but the operation of this is typically very energy-intensive. This is particularly problematic in the case of hearing devices which are mobile devices and are therefore not connected to a fixed power supply but supplied with power by means of an energy storage unit installed in the hearing device. Often, the capacity of the interface, e.g. bandwidth, is limited, so that data exchange with an increasing number of connections is difficult.

### BRIEF SUMMARY OF THE INVENTION

Against this background, an object of the invention is to improve the networking of hearing devices in a shared network. The networking and operation of the network should be as efficient as possible, so that the data exchange is as error-free, fast and energy efficient as possible.

The object is achieved according to the invention by a method having the features as claimed in the independent method claim and by a hearing device having the features as claimed in the independent hearing device claim. Advantageous configurations, extensions and variants form the subject matter of the dependent claims. In these the comments in relation to the method apply, mutatis mutandis, also to the hearing device, and vice versa. If method steps are described in the following, advantageous configurations for the hearing device are obtained in particular by the fact that the latter is designed to execute one or more of these method steps.

The method is used to operate a network containing a plurality of hearing devices assigned to different users. The network therefore has a plurality of hearing devices, which are each a node of the network and are connected to each other in the network for data exchange purposes. Each of the hearing devices has an interface for exchanging data with the other hearing devices. The interface is also referred to as a communication interface. The interface is preferably a wireless interface, so that radio connections are formed between the hearing devices. A suitable interface is a WLAN, RF or Bluetooth antenna.

In the present case, the network is implemented as a ring network, within which a given hearing device is directly connected to only two other hearing devices and only indirectly to the remaining hearing devices, so that the data exchange within the network takes place from hearing device to hearing device in sequence. A given hearing device is therefore not directly connected to every other hearing device, instead each hearing device is only connected to two other hearing devices, in such a way that all hearing devices are at least indirectly connected to each other in a ring-like transmission and reception arrangement. However, this does not mean that the hearing devices are physically, i.e. spatially arranged in a ring, the term “ring-like” referring primarily to the data exchange. If there is no direct or indirect connection between two hearing devices, these are not nodes of the same network.

The ring network is characterized by a particularly small number of connections, which are formed in such a way that the hearing devices of the network are connected one after the other in a chain. In a single ring network with, for example, n hearing devices, each hearing device then has only two connections to other hearing devices, so that a total of n connections are then formed in the network. Reducing the number of connections also advantageously reduces the data traffic and the bandwidth required for data exchange in the network, resulting in improved transmission quality. The data are transmitted through the network from one hearing device to the next hearing device, figuratively speaking, in the form of a ring.

To connect to another network, one of the hearing devices is advantageously configured as a gateway, to provide collective data exchange with the other network. The other network is, e.g., also a ring network with hearing devices, or the internet or a WLAN. The gateway is therefore connected, on the one hand, to two other hearing devices in the ring network and on the other hand, to another hearing device or another type of device outside the ring network. The gateway sends the data both to the following hearing device in the ring network and to another network, as required. The hearing device that is configured as a gateway therefore performs an additional function to a regular hearing device function, namely an interface function between two networks. A gateway is characterized in particular by the fact that it bundles the data exchange of a network and thus of a plurality of hearing devices, and sends them collectively to another network, preferably to a corresponding gateway of the other network. If one or more hearing devices are present in the other network, they are then only connected to the other hearing devices of the ring network indirectly via the respective gateway. In particular, a gateway in one network is located opposite another gateway in another network, so that the two gateways control the data exchange between the two networks, preferably the entire data exchange.

During the data exchange, data is exchanged between the hearing devices. This data may include audio data, settings data or other data, or a combination of these. During the data exchange a certain volume of data is also transmitted, the size of which significantly influences the transmission quality of the connections. Because the available bandwidth for the data exchange is usually limited, an excessive amount of data will result in corresponding transmission losses and errors. However, the design as a ring network advantageously reduces the volume of data transmitted and received by a single hearing device significantly.

In the ring network, data exchange is in principle possible in two directions, i.e. from a hearing device to either of the two hearing devices to which the hearing device is connected. Both data exchange in one direction and data exchange in both directions are advantageously possible. Data exchange in both directions occurs, for example, in binaural hearing aids with two individual devices, in such a way that each individual device of a hearing aid exchanges data with other hearing devices in opposite directions.

The invention is based in particular on the finding that a direct connection of two hearing devices in the form of a peer-to-peer connection, i.e. without an intermediary auxiliary device, is particularly advantageous. Such a peer-to-peer connection makes it easy to exchange data efficiently. In the case of multiple hearing devices, every hearing device would then be connected to every other hearing device, resulting in a correspondingly high number of direct connections. The resulting network is then a complete peer-to-peer network in which each node is connected to every other node. As a result, the amount of data to be transferred and the energy and bandwidth required by a single interface increase.

A key idea of the invention is then, in particular, to simplify the networking of hearing devices by reducing the number of connections between the hearing devices, so that not every hearing device is necessarily connected to every other hearing device. The networking of hearing devices is structured in such a way that not only are they directly connected to each other in pairs for data exchange, but also that purely indirect connections are also possible, in which a third hearing device merely forwards data between two other hearing devices. Such indirect connections are created by configuring the network as a ring network and then using this to reduce the number of connections and also the required bandwidth. In addition, this advantageously allows distances to be covered that are larger than the range of the interface of a hearing device. Overall, this reduces the energy requirements of each hearing device.

In a preferred embodiment, any two hearing devices are connected in the form of a peer-to-peer connection, i.e. connected to each other directly. This does not mean that every hearing device is directly connected to every other available hearing device, but that if two hearing devices are directly connected to each other within the ring network, the associated connection is a direct connection. This means that an additional switching device, e.g. a relay or a router, is not required to make the connection. The data is transmitted between two directly connected hearing devices from one interface to the other directly.

In a suitable design, the data exchange in the network takes place via a ring bus, on which data of any given hearing device can be mixed and over which data is sent to a respective hearing device in sequence. In other words, a ring bus is formed in the ring network, to which each of the hearing devices writes its respective data—if available—and from which these data are then read by other hearing devices. The data is forwarded along the ring bus step by step from one hearing device to the next hearing device. In particular, the data finally arrives back at the hearing device that originally sent the data. This hearing device then performs an error check or error correction, for example, and re-sends the data, for example. On reaching the hearing device that originally sent the data, it is advantageous to delete the data from the ring bus in order to reduce the volume of data.

Preferably, the network has a separate ring channel for each of the hearing devices, on which data from the hearing device is sent to the rest of the hearing devices. In particular, multiple parallel ring channels are formed, on each of which one of the hearing devices transmits data and the other hearing devices receive this data. The ring bus is thus divided into a plurality of ring channels running side by side. Each ring channel is assigned to exactly one of the hearing devices and also only carries data of this one hearing device. Thus, for each individual hearing device the assignment of the data to one of the other hearing devices is advantageously unique.

Advantageously, the network is set up automatically as soon as more than one hearing devices are located in close proximity to each other. This ensures that only the hearing devices of users who potentially want to talk to each other will become nodes of the network. The connections between the hearing devices are set up in particular in advance, without the need for a prior data exchange. This ensures that, if the need arises, the network already exists and does not first have to be set up, which would usually give rise to a corresponding time delay. The phrase “located in close proximity to each other” means, in particular, that a spatial distance between two hearing devices does not exceed a minimum distance. For example, the minimum distance is between 1 m and 10 m. In particular, the minimum distance corresponds to a maximum range of the interface of a particular hearing device.

In an advantageous design, during the data exchange a given hearing device transmits audio data which is captured by means of a microphone of the hearing device. In other words, over the network, audio data generated by each of these hearing devices by means of a microphone is exchanged between the hearing devices. The transmission of audio data described means that, in a sense, a radio transmission is implemented by means of which interfering background noise is reduced or completely suppressed. The sound of a user is not required to reach another user via an air link, rather the direct transmission of sound is replaced by a radio transmission of audio data which is generated from the sound. The audio data is in the form of electrical signals. The microphone captures sound from the environment and converts it into audio data. The audio data is preferably generated by a hearing device in any case, in order to modify it by means of a signal processor of the hearing device and output it to its user again as sound via a receiver of the hearing device.

Preferably, one or more or all of the hearing devices in the network are hearing aids for treating a hearing-impaired user. The audio data is then modified in the signal processor, in particular based on an individual audiogram, in such a way that a hearing deficit of the associated user is compensated. Advantageously, however, the audio data transmitted over the network is not modified by the signal processor of the same hearing device, at least not in order to compensate for a hearing deficit, since the hearing deficit is individual and the associated modification is therefore typically individually adapted, and hence is not necessarily suitable for other users. The audio data generated by a hearing device is thus, on the one hand, transmitted to the other hearing devices via the ring network and, on the other hand, modified and output in the signal processor. The audio data which a first hearing device receives from a second hearing device via the ring network is advantageously modified in the signal processor of the first hearing device and thus, if appropriate, adapted to an individual hearing deficit of the user of the first hearing device. For example, the audio data of the second hearing device together with the audio data of the first hearing device is fed into the signal processor and jointly modified there.

In a preferred design, the microphone captures the voice of the hearing device user as audio data and only transmits audio data when the user of the hearing device him/herself is speaking. In other words, the transmission of audio data is limited to periods of the user's own speech activity. The audio data therefore primarily comprises the voice of the user of a particular hearing device. This means that audio data is only transmitted when relevant data is actually available, and thus the total amount of data transmitted on the network is advantageously reduced.

The audio data is either real or synthetic audio data. For example, real audio data is simply an electrical output signal of the microphone. Synthetic audio data differs from real audio data in particular in that additional processing takes place in the hearing device before transmission, which advantageously leads to data reduction. In an advantageous design, during processing the audio data is converted by means of a processing unit into audio data, i.e. synthetic audio data for a synthesizer, which is designed to generate real audio data from this synthetic audio data. While real audio data from another hearing device can be output directly after being received, synthetic audio data must first be further processed, for example with a synthesizer integrated into a control unit of the hearing device, and then converted into real audio data. This results in an advantageous design, because the audio data is synthetic audio data for a synthesizer of a particular hearing device.

Conveniently, it is determined whether the user him/herself is speaking by checking whether an input level of the microphone exceeds a threshold value. Since the hearing device and therefore also the microphone are worn by the user on the head, the user's own voice accounts for a non-negligible proportion of the total sound that reaches the microphone. This proportion is increased in an advantageous design by the fact that the microphone is a directional microphone which is oriented toward the user's mouth, i.e. it primarily picks up sound from there. To check whether the input level exceeds the threshold value, the input level is measured and compared with the threshold value. Without actually recognizing the user's own voice, it is then assumed that a high input level indicates the user's own speech activity. Thus, in a simple and sufficiently reliable way, the transmission of audio data is at least predominantly limited to periods of the user's own speech activity.

Alternatively or in addition to measuring the input level, in a suitable design, own-voice detection of the respective hearing device is used to determine whether the user him/herself is speaking. The own-voice detection is characterized in particular by the fact that it ensures that the user's own voice is actually detected. The own-voice detection is implemented in a control unit of the hearing device, for example, in circuit technology or software technology. For example, the own-voice detection system aligns a directional microphone of the hearing device toward the user's mouth in order to primarily record the user's voice. Also suitable is a design in which a microphone of the hearing device is placed in the user's auditory canal, so that this microphone primarily records the user's own voice.

As an alternative or in addition to audio data, in an advantageous design a hearing device transmits settings data during the data exchange, for setting one or more operating parameters of a hearing device. The settings data is also known as configuration data, because it can be used, and in particular is used, to configure a hearing device. Example operating parameters are sound volume, filter characteristics, threshold values, width or direction of a directional microphone and the like. For example, the settings data are specific values for one or more operating parameters or environmental data which describe the current environment and from which a hearing device then derives suitable values for operating parameters. This is particularly advantageous in a situation in which a hearing device joins the network and then by receiving the settings data, automatically configures itself optimally to the current environment particularly simply and quickly without first having to determine the settings data itself.

If audio data is transmitted during the data exchange, in an advantageous design a background noise is added to it. This is based on the consideration that the audio data may sound unnatural when output, for example if it was recorded with a microphone in a user's auditory canal or if it was produced with a synthesizer. By mixing in a background noise, a more natural sound is achieved.

How the background noise is actually mixed in is not particularly relevant. In a particularly advantageous design, however, the background noise from one of the hearing devices is added, which is configured as a master of the network for this purpose so that all hearing devices receive and, in particular, also output the same background noise. If multiple ring channels are present, the background noise is either mixed onto one or more of the ring channels, e.g. only on the ring channel of the master, or else the ring network has an additional background channel on which the background noise is additionally transmitted, in parallel with the ring channels. For example, the background noise is a noise signal. For example, the background noise is artificially generated by the master, captured from the environment, or stored in a memory of the master as an audio file and then retrieved.

Also, regardless of the addition of background noise, in general one of the hearing devices is assigned the role of a master in the network, which in particular coordinates the entry and exit of hearing devices into or out of the network. All other hearing devices, on the other hand, are assigned the role of a slave, which is dependent on the control of the network by the master. This distribution of roles is carried out, in particular, as soon as at least two hearing devices are present. For example, each hearing device regularly broadcasts a search signal which is received and confirmed by another hearing device, so that two hearing devices acquire knowledge of each other by mutual reception and confirmation and then form a network spontaneously and, in particular, automatically. A similar process applies when a hearing device joins an existing network.

If one of the hearing devices is configured as a gateway as described above, the hearing device which is already the master is preferably used for this purpose.

A suitable hearing device is configured to carry out a method as described above. For this purpose, the hearing device appropriately comprises a control unit, which is configured in such a way that it carries out the corresponding method. In the control unit, the method is implemented, in particular, in software or circuit technology, or a combination of these. For example, the control unit is configured as a microprocessor or as an ASIC or a combination of these. The control unit mentioned here is preferably the same control unit as the control unit mentioned above.

A hearing device is preferably a monaural or binaural hearing aid. A binaural hearing aid contains two separate devices, which are worn by the user on different sides, i.e. in or on the left and right ears. A monaural hearing aid only has a single device, which is worn by the user on or in the left or right ear.

Other features which are considered as characteristic for the invention are set forth in the appended claims.

Although the invention is illustrated and described herein as embodied in a method for operating a network, and a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram showing a hearing device;

FIG. 2 is an illustration of a network;

FIG. 3 is an illustration of a variant of the network of FIG. 2;

FIG. 4 is an illustration of another variant of the network of FIG. 2I

FIG. 5 is a block diagram showing a variant of the hearing device of FIG. 1; and

FIG. 6 is a block diagram showing another variant of the hearing device of FIG. 1.

### DETAILED DESCRIPTION OF THE INVENTION

Referring now to the figures of the drawings in detail and first, particularly to FIG. 1 thereof, there is shown an exemplary hearing device 2, which is used here specifically for treating a hearing-impaired user N, not shown explicitly in FIG. 1. To this end the hearing device 2 has a microphone 4, which captures sound from the surroundings and generates an electrical input signal, i.e. audio data A, A′ (hereafter referred to simply as “A” without restriction of generality). This audio data A is fed to a signal processor 6 of the hearing device 2 for modification. The modification is carried out in particular on the basis of an individual audiogram of the user N which is assigned to the hearing device 2, so that an individual hearing deficit of the user N is compensated. The result of the signal processor 6 is to output an electrical output signal, which is then converted back into sound via a receiver 8 of the hearing device 2 and output to the user N. In the exemplary embodiment shown, the signal processor 6 is part of a control unit 10 of the hearing device 2.

The hearing device 2 is also subscribed to a network 12 as a node for exchanging data with other hearing devices 2 assigned to other users N. An exemplary network 12 is shown in FIG. 2. The number of nodes can vary dynamically during operation by new hearing devices 2 joining the network 12 or by subscribed hearing devices 2 leaving the network 12. Each of the hearing devices 2 has an interface 14 for exchanging data with the other hearing devices 2. The networks 12 shown as examples are wireless networks 12, the interfaces 14 are accordingly wireless interfaces, e.g. WLAN, Bluetooth or RF antennas. In addition, each hearing device 2 also has an energy storage unit 16.

Each hearing device 2 here is a monaural or a binaural hearing aid 2. A combination of different hearing aids 2 in the same network 12 is entirely possible.

In the present case, the network 12 is implemented as a ring network, within which a given hearing device 2—as is clear from FIG. 2—is directly connected to only two other hearing devices 2 and only indirectly connected to the remaining hearing devices 2, so that as part of a method for operating the network 12 the data exchange within the network 12 takes place from hearing device 2 to hearing device 2 in turn. A given hearing device 2 is therefore not directly connected to every other hearing device 2, instead each hearing device 2 is only connected to two other hearing devices 2, in such a way that all hearing devices 2 are at least indirectly connected to each other in a ring-like transmission and reception arrangement. However, this does not mean that the hearing devices 2 are physically, i.e. spatially arranged in a ring, the term “ring-like” referring primarily to the data exchange.

The ring network is characterized by a particularly small number of connections V, which are formed in such a way that the hearing devices 2 of the network 12 are connected one after the other in a chain. In the ring network shown in FIG. 2 with, for example, six hearing devices 2, each hearing device 2 then has only two connections V to other hearing devices 2, so that a total of six connections V are then formed in the network 12. Reducing the number of connections V also advantageously reduces the data traffic and the required bandwidth for data exchange in the network 12. The data then travel through the network 12 from one hearing device 2 to the next hearing device 2, figuratively speaking, in the form of a ring.

For example, to connect to another network 18, as shown in FIG. 3 for example, one of the hearing devices 2 of the network 12 is configured as a gateway 20 for collective data exchange with the other network 18. The other network 18 is, e.g., also a ring network with hearing devices 2, or the internet or a WLAN. The gateway 20 is therefore connected, on the one hand, to two other hearing devices 2 in the ring network and, on the other hand, to another hearing device 2 or another type of device outside the ring network, not explicitly shown in FIG. 3.

During the data exchange, data is exchanged between the hearing devices 2. This data may include audio data A, settings data E or other data, or a combination of these. FIG. 1 shows an example of the transmission of audio data A and settings data E using the interface 14. During the data exchange a certain volume of data is also transmitted, the size of which significantly influences the transmission quality of the connections V. The configuration as a ring network significantly reduces the volume of data transmitted and received by a single hearing device 2.

In the ring network, data exchange is in principle possible in two directions, i.e. from one hearing device 2 to either of the two hearing devices 2 to which the hearing device 2 is connected. Both data exchange in one direction only and data exchange in both directions are advantageously possible. In FIGS. 2 and 3, for example, data exchange takes place in one direction, namely counter-clockwise. Data exchange is also possible in both directions, i.e. clockwise and counter-clockwise. Data exchange in both directions occurs, for example, in a configuration not explicitly shown of binaural hearing aids 2 with two individual devices, in such a way that each individual device of a hearing device 2 exchanges data with other hearing devices 2 in opposite directions.

The networking of hearing devices 2 in the exemplary embodiment shown is structured in such a way that not only are the hearing devices 2 simply directly connected to each other in pairs for data exchange, but also that purely indirect connections are also possible, in which a third hearing device merely forwards data between two other hearing devices 2. Such indirect connections are created by configuring the network 12 as a ring network and then using this to reduce the number of connections V and also the required bandwidth. In addition, this may also allow distances to be covered that are larger than the range of the interface 14 of a hearing device 2.

In this case, any two hearing devices 2 are connected in the form of a peer-to-peer connection, i.e. directly connected to each other. This does not mean that every hearing device 2 is directly connected to every other available hearing device 2, but that if two hearing devices 2 are directly connected to each other within the ring network, the associated connection V is a direct connection, as is shown in FIGS. 2 and 3. This means that an additional switching device, e.g. a relay or a router, is not required to make the connection. The data is transmitted between two directly connected hearing devices 2 directly from the one interface 14 to the other interface 14.

In addition, the data exchange in the network 12 is carried out via a ring bus 22, an exemplary embodiment of which is shown in FIG. 4. Data from a respective hearing device 2 can be added to the ring bus 22. Specifically, in FIG. 4 both audio data A and settings data E are placed on the ring bus 22 by each hearing device 2 as data, which is then read by the other hearing devices 2. The data is then sent in sequence to a particular hearing device 2 on the ring bus 22. The data is forwarded along the ring bus 22 step by step from one hearing device 2 to the next hearing device 2. In particular, the data finally arrives back at the hearing device 2 that originally sent the data.

In FIG. 4, the network 12 has a separate ring channel 24 for each of the hearing devices 2, on which data of the hearing device 2 is sent to the remaining hearing devices 2. This creates a plurality of parallel ring channels 24, on which one of the hearing devices 2 transmits data and the other hearing devices 2 receive this data. For example, the first hearing device 2 on the far left in FIG. 4 places audio data A and settings data E on the outermost ring channel 24 of the ring bus 22. This audio data A and settings data E are read by the last hearing device 2 at the far right of FIG. 4. At the same time, this last hearing device 2 also writes audio data A and settings data E to the ring bus, but to its own ring channel 24, which in FIG. 4 is the innermost ring channel 24. The ring bus 22 is therefore divided into a plurality of ring channels 24 running side by side. Each ring channel 24 is assigned to exactly one of the hearing devices 2 and also only carries data of this one hearing device 2. Thus, for each individual hearing device 2 the assignment of the data to one of the other hearing devices 2 is unique.

The network 12 is set up automatically as soon as a plurality of hearing devices 2 are located in close proximity to each other, thus ensuring that only those hearing devices 2, the users N of which would potentially like to talk to each other, become nodes of the network 12.

In the examples shown, each hearing device 2 transmits audio data A during the data exchange, which is captured by means of a microphone 4. Sending audio data A as described causes a radio transmission to be implemented, by means of which disturbing background noise is reduced or completely suppressed. The microphone 4 captures sound from the environment and converts it into audio data A, as shown in FIG. 1. The audio data A is preferably generated anyway by the hearing device 2 in FIG. 1, in order to modify this data by means of the signal processor 6 and to output it again to the user N as sound via the receiver 8.

Since the hearing device 2 in FIG. 1 is a hearing device 2 for treating a hearing-impaired user N, the audio data A is modified in the signal processor 6 in such a way that a hearing deficit of the user N is compensated. However, the audio data A transmitted over the network 12 is not modified by the signal processor 6 of the same hearing device 2, at least not to compensate for a hearing deficit, since the hearing deficit is individual. The audio data A generated by a hearing device 2 is thus, on the one hand, transmitted to the other hearing devices 2 via the ring network and, on the other hand, modified in the signal processor 6 and output. The audio data A, which a first hearing device 2 receives from a second hearing device 2 via the ring network, is modified in the signal processor 6 of the first hearing device 2, however, and thus adapted, if appropriate, to an individual hearing deficit of the user N of the first hearing device 2. For example, the audio data A of the second hearing device 2 together with the audio data A of the first hearing device 2 is fed into the signal processor 6 and jointly modified there. This is indicated in FIG. 1 by the two arrows pointing in opposing directions from the interface 14 to the signal path between microphone 4 and signal processor 6. The user's own audio data A is directed to the interface 14 and transmitted via the latter, and also to the signal processor 6. In addition, audio data A is received via the interface 14 and mixed with the audio data A originating from the microphone 4, the combined signal being routed to the signal processor 6 where it is modified. The same procedure is used for the settings data E, these being supplied and processed by the control unit 10, e.g. to adjust the signal processor 6.

Optionally, the microphone 4 records the voice of the user N of the respective hearing device 2 as audio data A, and only transmits audio data A when the user N of the hearing device 2 is speaking him/herself. In other words, the transmission of audio data A is limited to periods of the user's own speech activity.

The audio data A is either real or synthetic audio data A. For example, real audio data A is simply an electrical output signal of the microphone 4. Synthetic audio data A differs from real audio data A in particular in the fact that additional processing takes place in the hearing device 2 before transmission, which advantageously leads to a data reduction. For example, as shown in the design of FIG. 5, during processing the audio data A is converted by means of a processing unit 26 into audio data A′ for a synthesizer 28, which is designed to generate real audio data A from this synthetic audio data A′. While real audio data A from another hearing device 2 can be output directly after being received, synthetic audio data A′ must first be further processed, here with the synthesizer 26, which is integrated into the control unit 10 of the hearing device 2 and then generates real audio data A.

In a design not explicitly shown, it is determined whether the user N him/herself is speaking, by checking whether an input level of the microphone 4 exceeds a threshold value. Since the hearing device 2 and therefore also the microphone 4 are worn by the user N on the head, the user's own voice accounts for a non-negligible proportion of the total sound which reaches the microphone 4. Alternatively or in addition to this, as shown in e.g. FIG. 6, own-voice detection 30 of the respective hearing device 2 is used to determine whether the user N him/herself is speaking. The own-voice detection 30 here is implemented in the control unit 10 of the hearing device 2 either in circuit technology or software technology.

As an alternative or in addition to audio data A, a given hearing device 2 transmits settings data E during the data exchange as described, for setting one or more operating parameters of a hearing device 2. The sending and receiving of audio data A is in principle independent of the sending and receiving of settings data E. Example operating parameters are sound volume, filter characteristics, threshold values, width or direction of a directional microphone and the like. For example, the settings data E are specific values for one or more operating parameters or environmental data which describe the current environment and from which a hearing device 2 then derives suitable values for operating parameters.

If audio data A is transmitted during the data exchange, in a possible design an additional background noise is added to it. For example, the background noise is mixed in by one of the hearing devices 2, which is configured as a master 32 of the network 12 for this purpose, so that all hearing devices 2 receive and, in particular, also output the same background noise. For illustration purposes and purely as an example in the exemplary embodiment of FIG. 4, the first hearing device 2 on the far left is additionally configured as a master 32 and mixes the background noise onto its ring channel 24. In a variant not shown, the ring network has an additional background channel on which the background noise is additionally transmitted in parallel to the ring channels 24. For example, the background noise is a noise signal. For example, the background noise is artificially generated by the master 32, captured from the environment, or stored in a memory of the master 32 as an audio file and then retrieved.

The individual concepts which have been described in connection with the individual figures are essentially independent of each other and can be combined as required. In this respect, further exemplary embodiments result from a combination of individual aspects of the exemplary embodiments shown.

The following is a summary list of reference numerals and the corresponding structure used in the above description of the invention:
2 hearing device
4 microphone
6 signal processor
8 receiver
10 control unit
12 network
14 interface
16 energy storage unit
18 other network
20 gateway
22 ring bus
24 ring channel
26 processing unit
28 synthesizer
30 own-voice detection
32 master
A, A′ audio data
E settings data
N user

1. A method for operating a network having a plurality of hearing devices assigned to different users, each of the hearing devices having an interface for exchanging data with other ones of the hearing devices, which further comprises:
implementing the network as a ring network, within which a given hearing device is directly connected to only two other of the hearing devices and only indirectly connected to remaining ones of the hearing devices, so that a data exchange within the network takes place from hearing device to hearing device of the hearing devices in sequence.

2. The method according to claim 1, wherein the hearing devices are each directly connected to each other in a form of a peer-to-peer connection.

3. The method according to claim 1, wherein the data exchange in the network takes place via a ring bus, on which the data of a respective hearing device of the hearing devices can be mixed together and the data are sent to the hearing devices in sequence.

4. The method according to claim 1, wherein the network has a separate ring channel for each of the hearing devices, on which the data of the hearing device is sent to a rest of the hearing devices.

5. The method according to claim 1, wherein the network is set up automatically as soon as a plurality of the hearing devices are disposed in close proximity to each other.

6. The method according to claim 1, wherein the given hearing device transmits audio data during the data exchange, which is recorded by means of a microphone of the given hearing device.

7. The method according to claim 6, wherein the microphone records an own voice of a user of the given hearing device as the audio data, and the given hearing device only transmits the audio data when the user of the given hearing device him/herself is speaking.

8. The method according to claim 6, wherein the audio data is synthetic audio data for a synthesizer of a particular one of the hearing devices.

9. The method according to claim 6, wherein it is determined whether a user him/herself is speaking by checking whether an input level of the microphone exceeds a threshold value.

10. The method according to claim 6, wherein an own-voice detection in the given hearing device is used to determine whether the user him/herself is speaking.

11. The method according to claim 1, wherein the hearing device transmits settings data during the data exchange for setting at least one operating parameter of one of the hearing devices.

12. The method according to claim 6, wherein the audio data is additionally mixed with background noise and is transmitted during the data exchange.

13. The method according to claim 12, wherein the background noise is mixed in by one of the hearing devices, which is configured as a master of the network so that all the hearing devices receive a same background noise.

14. A hearing device, comprising:
a controller programmed to perform the method according to claim 1.
